(19) United States
(12) Patent Application Publication
(10) Pub. No.: US 2008/0078453 A1
(43) Pub. Date: Apr. 3, 2008

(54) Metallic Valve

(75) Inventor: Jurgen Sander, Saarbrucken (DE)

Correspondence Address: HARNESS, DICKEY & PIERCE, P.L.C., P.O. BOX 828, BLOOMFIELD HILLS, MI, 48303, US

(73) Assignee: NANOGATE AG, Saarbrucken (DE)

(21) Appl. No.: 11/536,836

(22) Filed: Sep. 29, 2006

(51) Int. Cl. F16L 7/00

(52) U.S. Cl. 137/375

(57) ABSTRACT

The invention relates to a metallic valve, characterized in that the valve disk and/or the valve seat has a ceramic coating with a layer thickness within a range of from 10 to 1000 nm.

### BACKGROUND

The invention relates to a metallic valve, especially of an exhaust gas recirculation system of a combustion engine wherein the valve disk has a ceramic coating.

On the sealing surfaces of valves of the exhaust gas recirculation systems of combustion engines, a condensate from the exhaust gases of the combustion chambers deposits. Such condensates change into tarry, sooty residues which agglutinate the sealing surfaces of the valves. Thus, a higher force is required to open the valves. In the following, this force is referred to as “withdrawal force”. Usually, the valves must be able to withstand temperatures in a range of from 400 to 450° C. In more recent engines, the exhaust gases are partially precooled, which may lead to increased condensate formation in the valve.

EP 1 247 956 A2 describes a thermal protection layer of zirconia which may have a layer thickness of 80 μm.

WO 02/23033 A1 describes a silicate coating having a layer thickness of between 2 and 9 μm on valve disks of exhaust recirculation valves for improving the running performance.

U.S. Pat. No. 4,106,449 A describes a PTFE coating of parts of an exhaust recirculation valve for preventing the adhesion of the condensates being formed. This valve coating is designed for exhaust temperatures within a range of from 200 to 300° C.

U.S. Pat. No. 4,497,335 A describes a Teflon coating of a valve seat in a control valve of an exhaust gas recirculation system.

DE 10163646 A1 describes an anti-adhesion coating in which a ceramic material, a metal, a cement with a porous structure is applied to a substrate, followed by applying an inorganic-organic nanocomposite material which fills in the pores of the underlying porous material.

DE 19929616 A1 describes a coating agent for protection from thermal oxidation that consists of a phosphosilicate nanosol.

U.S. Pat. No. 5,052,349 A describes the coating of a combustion chamber with zirconia as a thermal protection.

U.S. Pat. No. 4,346,870 A describes the application of a zirconia plate to a valve disk by means of a flange as a thermal protection.

U.S. Pat. No. 6,679,476 B2 describes a valve arrangement in which the valve seat may be made of zirconia, and the valve disk of ceramics. Neither the valve seat nor the valve disk have a coating.

U.S. Pat. No. 6,460,559 B2 describes a valve arrangement in which both the seat and the spring may be ceramic. The parts of this valve are not coated.

### SUMMARY

It is the object of the present invention to provide a coating of a metallic valve, especially of an exhaust gas recirculation system of a combustion engine, which coating reduces the force required to open the valve when the valve disk and/or the valve seat is contaminated with an exhaust gas condensate, or prevents or at least reduces the adhesion of contaminations.

In a first embodiment, the above object is achieved by a metallic valve, especially of an exhaust gas recirculation system of a combustion engine, characterized in that the valve disk and/or the valve seat has a ceramic coating with a layer thickness within a range of from 10 to 1000 nm.

The applicability of the technology according to the invention is not limited to metallic valves of exhaust gas recirculation systems of combustion engines, but can be employed with all valves which must be heat-resistant and are prone to agglutination.

In addition, the coating may be employed on metallic surfaces which come into contact with exhaust gas condensates, especially in the exhaust gas system, exhaust gas cooler, piston, compressor blade or throttle valves.

When the previously known coating systems for valve disks were developed further, it has been surprisingly found that just a particularly thin coating having a layer thickness of up to 1000 nm reduces the withdrawal force of the valve disk by up to 30% as compared to an uncoated valve disk. Also with respect to the previously known silicate coating, the withdrawal force could be reduced significantly with these particularly thin layers.

“Ceramic material” within the meaning of the present invention refers to an inorganic non-metallic material or an inorganic non-metallic mixture of materials which is sintered by a temperature treatment, preferably at about 500° C., during its preparation and is partially crystallized.

### DRAWINGS

FIG. 1 shows the EDX survey spectrum of the uncoated analytical range; and

FIG. 2 shows the EDX survey spectrum of the coated analytical range.

### DETAILED DESCRIPTION

According to the invention, ceramic coatings are necessary because usually temperatures of from 400 to 450° C. may occur in exhaust gas recirculation valves. In exceptional cases and particular engine constructions, such valves must also withstand temperatures of from 700 to 800° C. To date, regarding the mechanism of the mode of action of coatings of valve disks, it has been understood in the prior art that either a corrosion process must be prevented, or the grooves of the lathe-turned disks must be smoothed with a coating. However, since surprisingly just particularly thin coatings with layer thicknesses of <1 μm are particularly effective, the smoothing of the grooves in the lathe-turned disks cannot be the critical mechanism. Rather, the compactness and continuity of the coating seems to be critical. Thus, cracks in the layer were detected for layer thicknesses of >1 μm. Through such cracks, the condensate may come into contact with the metal or oxidized metal surface of the valve disk. Just upon direct contact of the condensate with the metal surface of the valve disk, a particularly heavy agglutination of the valve disk with the sealing surface of the valve seat seems to occur.

Advantageously, the layer thickness according to the invention of the coating is within a range of from 100 to 220 nm. Such particularly thin coatings result in a particularly high extent of reduction of the withdrawal forces.

Advantageously, the material of the coating according to the invention is selected from oxides of the metals of the 3rd, 4th and/or 5th main and auxiliary groups of the Periodic Table of chemical elements. Zirconia is particularly suitable as a coating material. According to the invention, it has been surprisingly found that just zirconia, which is not catalytically active, could reduce the withdrawal force to a particularly high extent. In addition to zirconia, above all, oxides of the auxiliary group metals and alkaline earth metals are also suitable, the latter for obtaining high-temperature resistant coatings. In addition to the oxides of the mentioned metals, nitrides, carbides and/or other temperature-resistant ceramic compounds of such metals may also be employed according to the invention.

Advantageously, the coating is applied at least to the sealing surface of the valve, since the coating on the sealing valves determines the reduction of the withdrawal forces. It is particularly advantageous if only the sealing surfaces are coated, since this may reduce the consumption of the coating material and thus render the process more economically efficient.

According to the invention, it is preferred if the valve disk is made of aluminum or steel, especially of stainless steel, because the valve has a longer service life and better closing properties if the valve disk consists of a harder material than that of the valve seat.

Therefore, it is also advantageous if the valve seat is made of aluminum or steel. For the above stated reasons, aluminum is particularly suitable for the valve seat because it is softer than stainless steel.

The valve according to the invention is advantageously a double-disk valve, because double the force must be applied for opening such valves when agglutinated. Since the coating according to the invention reduces the withdrawal force, it is particularly suitable for double-disk valves.

Preferably, the valve is characterized in that the force for opening the valve is lower than for an uncoated valve by at least 8% if the valve disk and/or valve seat is contaminated with exhaust gas condensate. This force is also referred to as “withdrawal force”. Thus, an additional motor for opening the valves can have smaller dimensions or even be omitted.

The ceramic coating can be applied, for example, by processes such as vacuum coating processes (for example, PVD or CVD) or vapor deposition. The painting or spraying of a metal alcoholate solution followed by curing at elevated temperature may also be employed for the coating process.

Preferably, the coating is applied in a spray-coating process. In this process, solutions of metal fatty acid salts are employed. Particularly preferred are metal salts of calcium, titanium, chromium, manganese, cobalt, zinc, iron, zirconium, barium, cerium, tin, lead and bismuth. Metal octanoates, especially zirconium octanoate, have proven particularly suitable. Alcohols, especially isopropanol, are particularly suitable as solvents. The solution can be applied as a lacquer by spraying, brushing or blade coating. Flow coating, dip coating or similar application methods are also preferred according to the invention. The curing of the thus applied coating is mostly effected at a temperature within a range of from 200 to 800° C., especially at about 500° C., and usually takes from 0.2 to 10 hours, especially about 1 hour. The temperature may optionally be varied within this time period.

### EXAMPLE

Withdrawal tests were performed on coated valve disks agglutinated with an adhesive on the valve seat; the withdrawal force for withdrawing the valve disk from the valve seat was measured and compared.

The object of the study is to establish a coating which reduces the withdrawal forces for opening an exhaust gas recirculation valve to ensure the function of the component.

Experimental set-up:

1. Valve seat and valve disk

A standard available valve seat made of cast aluminum from an exhaust gas system of a passenger car was used as the valve seat. A corresponding standard available valve disk of stainless steel was used as the valve disk.

2. Withdrawal apparatus

A valve seat of aluminum is attached to a deck of a stand. Attached to the stand rest above the valve seat, there is a commercially available spring scale with a maximum indicator (supplied by Kern, up to 200 N). The hook of the spring scale is connected through a Kevlar thread with the agglutinated valve disk (the valve disk is round and has a bore in the middle). Subsequently, the spring scale is moved upwards by the swivel lever at the stand rest until the Kevlar thread is under tension. Then, turning is continued slowly (about 1 cm per second on the spring scale corresponds to about 10 N/s) until the valve disk breaks off the valve seat. The maximum indicator marks the maximum force required.

For evaluation, comparative measurements were respectively performed. At least 3 uncoated and 3 coated valve disks were agglutinated on valve seats at one time and dried at 40° C. for 12 hours. Subsequently, the mean values of the detaching forces of uncoated and coated valve disks were compared.

3. Adhesive

Since an adhesive cannot be mimicked exactly in the laboratory due to the complex composition of exhaust gas condensates, a suitable adhesive was prepared for the laboratory purposes.

### Composition:

40 g of sucrose in 100 g of water, addition of 1 ml of 10% aqueous hydrochloric acid.

After every storage for 1 week at room temperature, this adhesive must be prepared again freshly.

4. Coating material

The following zirconium salt of octanoic acid was employed as the coating material:

400 g of a solution of:
68% by weight of octanoic acid, zirconium salt;
3.5% by weight of 2-(2-butoxyethoxy)ethanol
31.5% by weight of petroleum naphtha (hydrogen-treated petroleum);

400 g of 2-propanol.

Both were admixed with stirring. The solution became slightly turbid and could be used for about 2 days. The solution could be applied as a lacquer by spraying, brushing or blade coating. Flow coating and dip coating were also possible.

5. Application

The coating was applied only to the sealing surface of the valve disks. The application was effected by means of a commercially available paint spray gun (Sata).

6. Curing

The curing of the coating was effected at 500° C. The final temperature of 500° C. was maintained for 1 hour. The heating rate had no critical influence.

7. Result (withdrawal forces in [N])

| | Coating operations | | | | | | |
|---|---|---|---|---|---|---|---|
| Withdrawal forces in [N] | 1 | 2 | 3 | 4 | 5 | 6 | 7 |
| uncoated | 65.8 | 34 | 66.3 | 55 | 41.5 | 36.5 | 34 |
| coated with glass | 60.8 | 27.5 | 51.9 | 50.6 | 37.5 | 29 | 29 |
| (see WO 02/23033) | | | | | | | |
| ZrO₂ coating according | 50.8 | 25.5 | 45 | 45.8 | 34.5 | 27 | 26 |
| to the invention | | | | | | | |

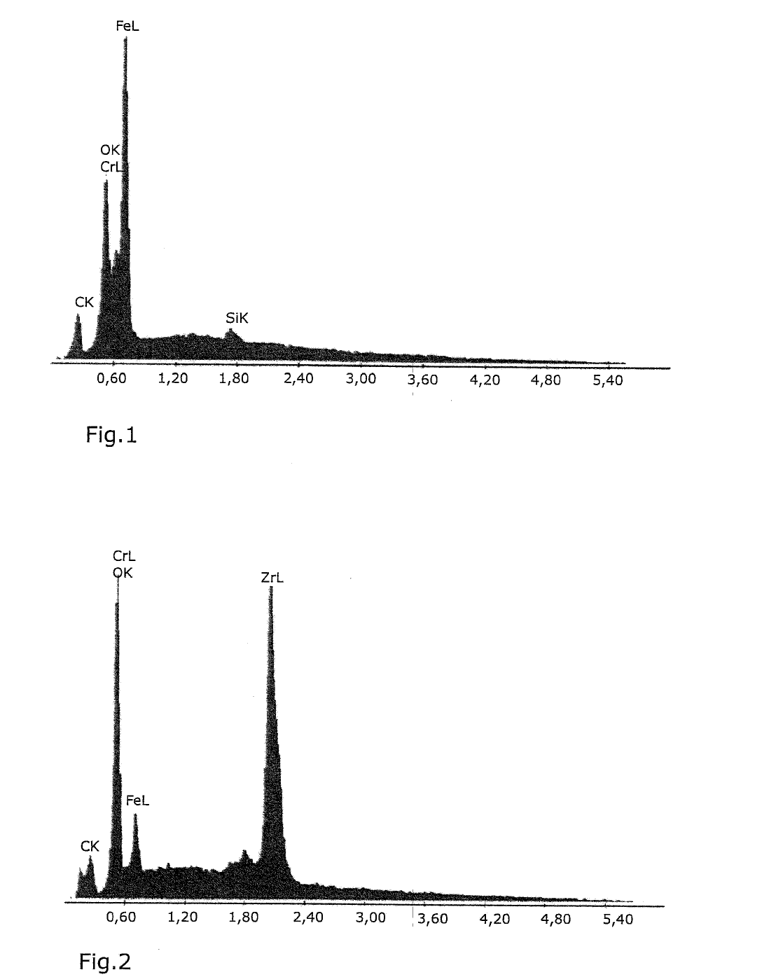

The layer thickness of the ZrO₂ coating was examined with a scanning electron microscope (environmental scanning electron microscope, ESEM) in combination with energy-dispersive X-ray analysis (EDX). By means of the ESEM, two analytical ranges for the EDX analysis (survey spectrum at an excitation voltage of 6 keV, measuring range 250 μm×250 μm) were selected: In one analytical range, the surface of the steel substrate is not coated with ZrO₂, and in the other analytical range, the surface of the steel substrate is coated with ZrO₂. FIG. 1 shows the EDX survey spectrum of the uncoated analytical range, and FIG. 2 shows the EDX survey spectrum of the coated analytical range. FIG. 2 shows a clear Zr L signal line. According to Castaing's algorithm, a maximum penetration depth of 220 nm results. Since clear signals from Fe and Cr are detected, the ZrO₂ layer has a layer thickness of lower than 220 nm. Further, a Monte Carlo method was employed (ZrO₂ density 5.7 g/cm³; excitation voltage 6 kV, beam diameter 30 nm, incident angle 90°) to simulate the paths of the high-energy electrons in the EDX method. With this method, the layer thickness could be estimated to be 100 to 150 nm.

1. A valve assembly comprising a valve disk and valve seat, characterized in that the valve disk and/or the valve seat has a ceramic coating with a layer thickness within a range of from 10 to 1000 nm.

2. The valve assembly according to claim 1, characterized in that the layer thickness of the coating is within a range of from 100 to 220 nm.

3. The valve assembly according to either of claims 1 or 2, characterized in that the material of the coating is selected from oxides of the metals of the 3rd, 4th and/or 5th main and auxiliary groups of the Periodic Table of chemical elements.

4. The valve assembly according to claim 1, characterized in that the coating has been applied at least to the sealing surface.

5. The valve assembly according to claim 1, characterized in that the valve disk consists of aluminum or steel.

6. The valve assembly according to claim 1, characterized in that the valve seat consists of aluminum or steel.

7. The valve assembly according to claims 1 or 2, characterized in that said valve is a double-disk valve.

8. The valve assembly according to claims 1 or 2 wherein the assembly is a component of an exhaust gas recirculation valve of a combustion engine.

9. The valve assembly according to claim 3, wherein said oxide is ZrO₂.

10. The valve assembly according to claim 5 wherein said steel is stainless steel.

11. A metallic valve assembly comprising a valve disk and valve seat, characterized in that the valve disk and/or the valve seat has a sealing surface which is coated with a ceramic material having a layer thickness within a range of from 10 to 1000 nm.

12. The metallic valve assembly according to claim 11, characterized in that the layer thickness of the coating is within a range of from 100 to 220 nm.

13. The metallic valve assembly according to either of claims 11 or 12, characterized in that the material of the coating is selected from oxides of the metals of the 3rd, 4th and/or 5th main and auxiliary groups of the Periodic Table of chemical elements.

14. The metallic valve assembly according to claim 11, characterized in that the valve disk consists of aluminum or steel.

15. The metallic valve assembly according to claim 11, characterized in that the valve seat consists of aluminum or steel.

16. The metallic valve assembly according to claims 11 or 12, characterized in that said valve is a double-disk valve.

17. The metallic valve assembly according to claims 11 or 12 wherein the assembly is a component of an exhaust gas recirculation valve of a combustion engine.

18. The metallic valve assembly according to claim 13, wherein said oxide is ZrO₂.
